(19) United States
(12) Patent Application Publication
(10) Pub. No.: US 2007/0075446 A1
(43) Pub. Date: Apr. 5, 2007

(54) Humidifier with sliding water tanks

(76) Inventors: Glenn Bushee, Duxbury, MA (US); Sin on Kwok, Kwai Chung (HK); Li Zheng, Zhejiang Province (CN); Sanjay Varma, Repulse Bay (HK)

Correspondence Address: Glenn Bushee, 1145 Franklin Street, Duxbury, MA, 02332, US

(21) Appl. No.: 11/540,941

(22) Filed: Sep. 28, 2006

Related U.S. Application Data
(60) Provisional application No. 60/722,558, filed on Oct. 3, 2005.

(51) Int. Cl. B01F 3/04

(52) U.S. Cl. 261/30; 261/72.1; 261/105

(57) ABSTRACT

A freestanding humidifier is provided with a movable base tray which is adapted to slide into and out of the bottom rear portion of the humidifier housing. The base tray is contoured to receive a pair of large volume water tanks which can be easily removed, refilled and reinstalled on the base tray. A large diameter fan is mounted in the humidifier and positioned to exhaust air in a substantially horizontal flow path from the humidifier into the ambient surroundings.

### CROSS REFERENCE TO RELATED APPLICATION

This application claims the benefit and priority of U.S. Provisional Patent Application No. 60/722,558 filed Oct. 3, 2005, the entirety of which is incorporated herein by reference.

### BACKGROUND OF THE INVENTION

1. Field of the Invention

The present invention relates to household humidifiers and in particular to a high-capacity front-exhausting humidifier having a sliding tray for facilitating removal and installation of water tanks.

2. Description of Prior Developments

High capacity household humidifiers require the use of large water tanks for providing a large supply of water for wetting the filters and wicks used to humidify a room over extended periods of time. Typical conventional high capacity humidifiers mount a single large water tank in an upper region of the humidifier housing.

This type of water tank mounting makes it difficult for an operator to remove and install the water tank. That is, an operator must reach down through the top of the humidifier housing to access a single large capacity tank holding 5 or 10 gallons of water. If the tank is empty, the tank may not be too difficult to remove, but if it holds several gallons of water weighing over eight pounds per gallon, the tank quickly becomes too heavy to freely and easily manipulate. This problem is particularly severe when an operator must try to lift and position a large tank of water through the top of a humidifier housing.

Another drawback of conventional humidifiers is the excessive wetting of the area immediately surrounding the humidifier housing. Conventional humidifiers typically blow moist air upwardly from the top of the humidifier housing. While this eventually humidifies the entire room, the limited horizontal component of air flow can cause an excessive concentration of water vapor and water droplets around the humidifier.

Accordingly, a need exist for a high capacity household humidifier which facilitates the installation and removal of relatively large capacity water tanks, and which improves air flow so as to reduce or eliminate the excessive wetting of surfaces surrounding the humidifier and to quickly fill a room with moist air.

### SUMMARY OF THE INVENTION

The present invention has been developed to meet the needs noted above by mounting one or more high capacity water tanks in the bottom of a humidifier casing. A sliding tray or platform is provided with a set of wheels or castors to allow the platform to be easily rolled into and out of the humidifier housing. The platform is configured to receive one, two or more water tanks and to automatically open the water tanks upon their proper placement on the platform.

Because the platform is located close to the ground, an operator need not lift a heavy water tank over the top of the humidifier casing and then lower it into the humidifier housing. In a preferred embodiment, two separate water tanks are provided so as to reduce by half the maximum weight of water that need be manipulated.

Another advantage of the present invention is the use of a front exhausting fan which blows moist are directly and substantially horizontally across a room. It has been found that this type of exhaust results in very quick humidification of an entire room and reduces or eliminates the wetting of surfaces around the humidifier. These advantages are further enhanced by the use of a single, high flow rate fan as opposed to prior designs which use two or more smaller fans with lower flow rates.

Various other objects, features and attendant advantages of the present invention will be more fully appreciated as the same becomes better understood from the following detailed description when considered in connection with the accompanying drawings, in which like reference characters designate like or corresponding parts through the several views.

### BRIEF DESCRIPTION OF THE DRAWINGS

In the drawings:

FIG. 1 is a front perspective view of a humidifier constructed in accordance with the invention;

FIG. 2 is a top front perspective view of the humidifier of FIG. 1;

FIG. 3 is a rear view of the humidifier of FIG. 1 showing a portion of the top cover;

FIG. 4 is a view of FIG. 3, with top and bottom back covers removed;

FIG. 5 is a top rear perspective view of the humidifier of FIG. 4, showing the water tanks mounted on a sliding or rolling base tray and removed from within the bottom of the humidifier;

FIG. 6 is a bottom view of the water tank of FIG. 5;

FIG. 7 is a rear perspective view of the humidifier of FIG. 5 with the water tanks removed and the base tray extended outwardly showing the details of the pump and water tank mounting sockets and water reservoir; and

FIG. 8 is an exploded schematic view of a humidifier configured in accordance with the invention;

### DESCRIPTION OF THE PREFERRED EMBODIMENTS

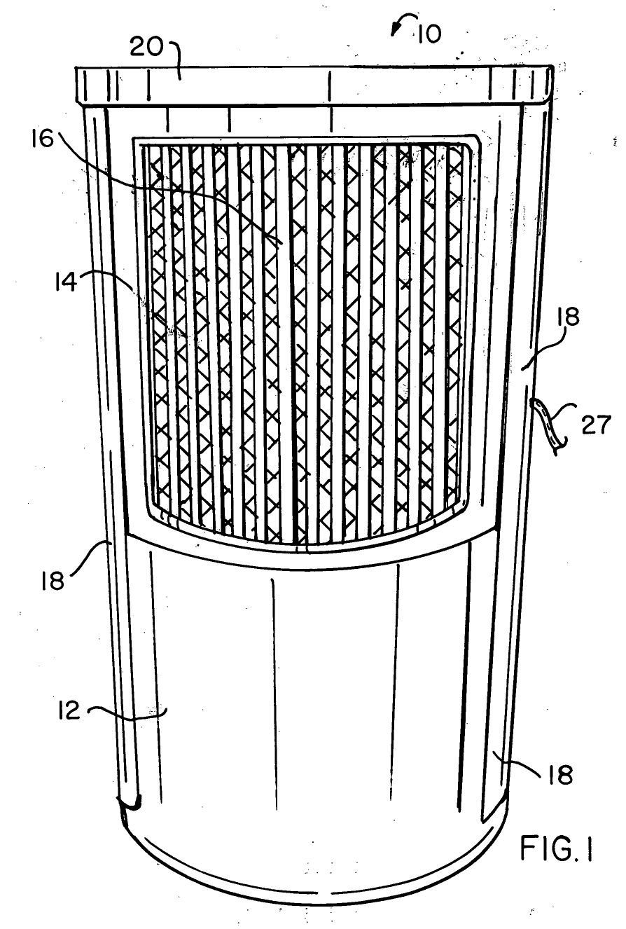

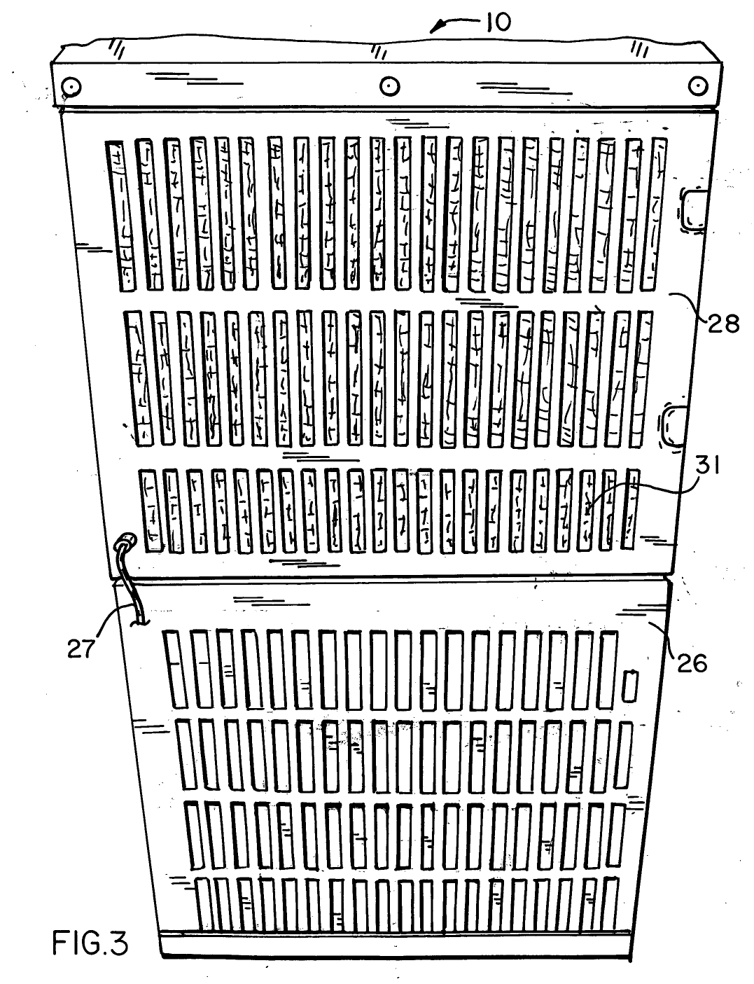

The present invention will now be described in conjunction with the drawings, beginning with FIGS. 1 and 3 which show a household humidifier 10 constructed in accordance with the invention. Humidifier 10 includes an outer housing formed of a bottom front panel 12 and a top front panel 14 having a large slotted front grill 16 formed therein for promoting free flow of moisturized air. The housing further includes a pair of side panels 18 and a top cover 20. A base or bottom is also provided, as discussed below.

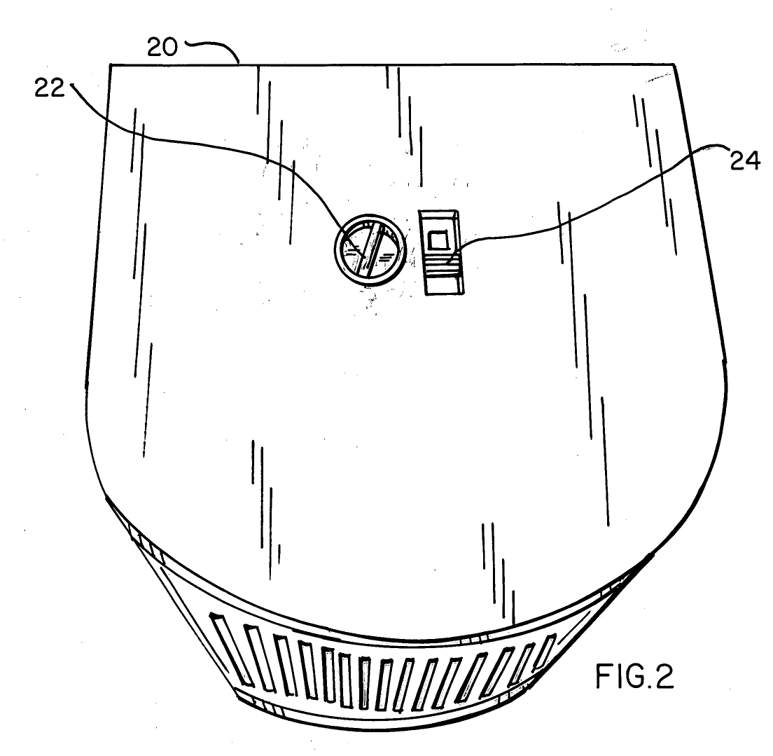

As seen in FIG. 2, the top cover 20 includes a moisture control knob 22 and a fan speed switch 24. As seen in FIG. 3, the humidifier housing further includes a bottom back cover 26 and a top back cover 28. The back covers 26 and 28 are designed to be easily and quickly removed without the aid of tools. Snap-fit connectors or tongue and groove sliding connections may be used to attach and detach the back panels to and from the humidifier 10. The humidifier is powered via power cord 27.

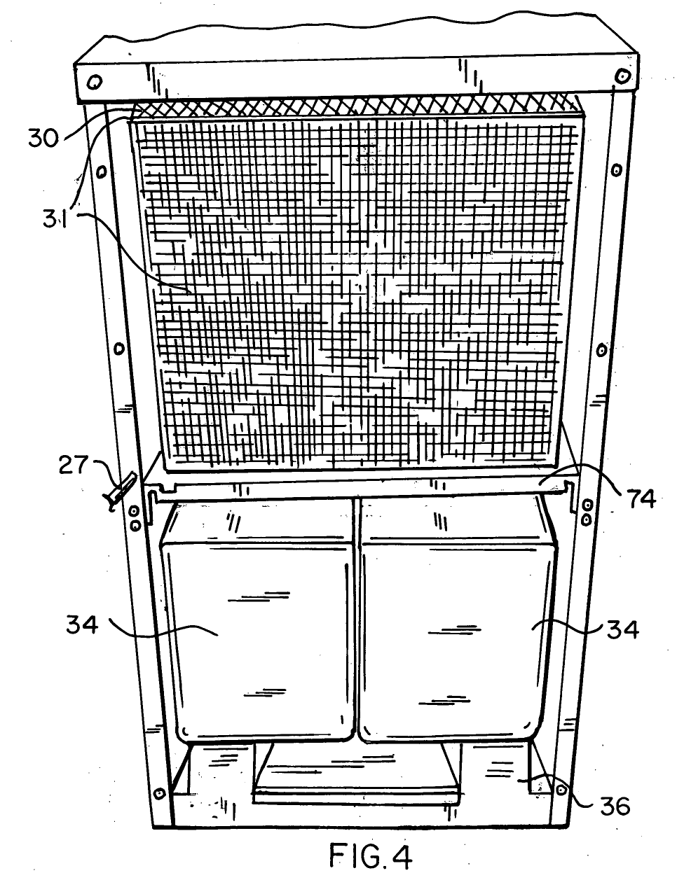

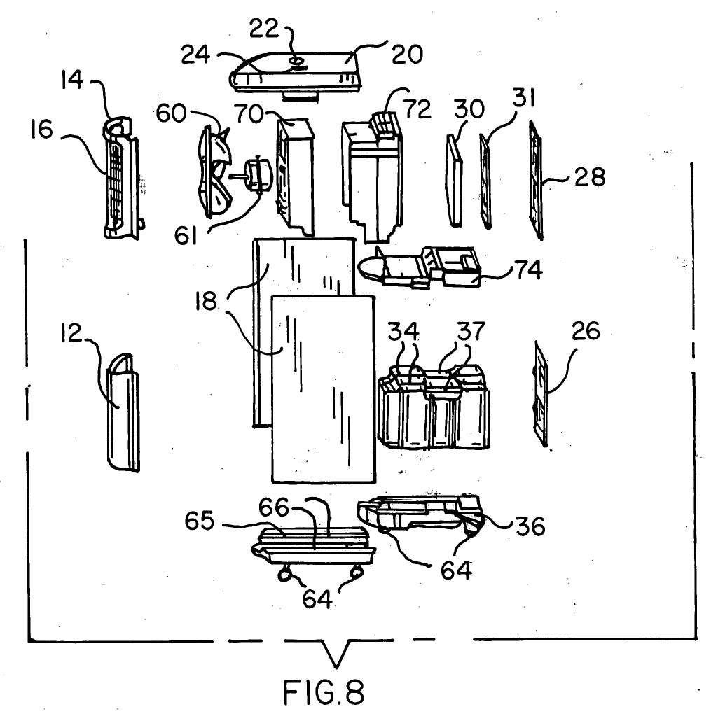

As seen in FIG. 4, the bottom and top back panels 26, 28 of FIG. 3 have been removed to clearly show a large fibrous water-absorbent honeycomb filter 30 mounted along the upper rear portion of the housing. Filter 30 can be formed of a natural paper material or a wicking type material, such as felt or or other woven or nonwoven material. As seen in FIGS. 3 and 8, a dust filter 31 is removably mounted with a grooved sliding, clamped, or latched fit with the inner surface of the top back cover 28, directly upstream of the honeycomb filter 30. Dust filter 31 removes dust and airborne particulates before they reach and clog the honeycomb filter 30.

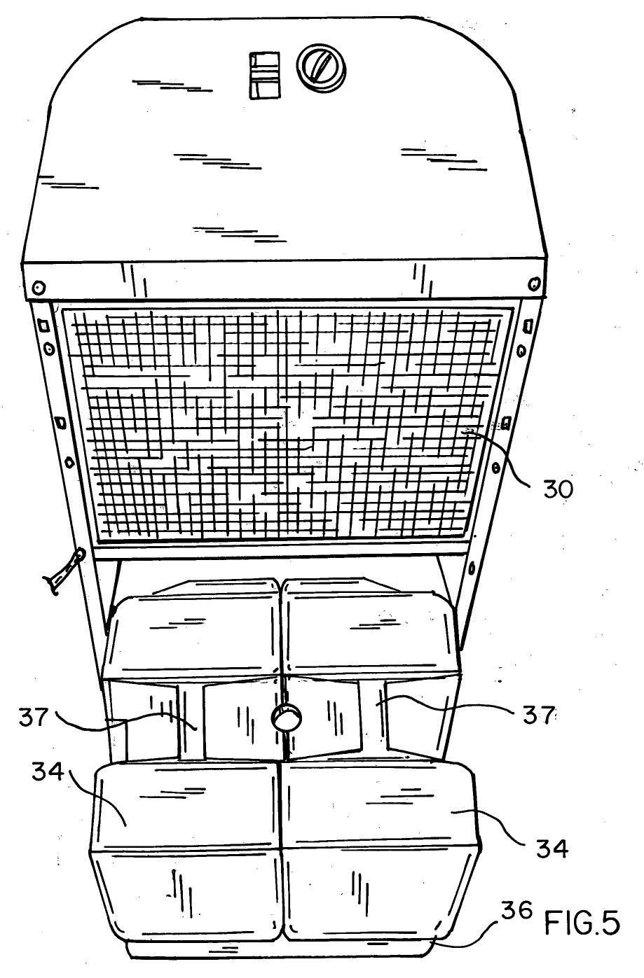

A pair of removable, plastic-molded water tanks 34 is shown in FIG. 4 mounted side-by-side in the bottom of the humidifier. The tanks 34 are carried by a sliding or rolling base tray 36. As seen in FIG. 5, each tank 34 is formed with an integral carry handle 37. The tanks are sized to carry about seven and one half gallons of water each, for a total of fifteen gallons. Of course, the tanks can be sized to carry any desired amount of water such as two, three, five, ten or even fifteen gallons each, depending on the space available in the humidifier housing.

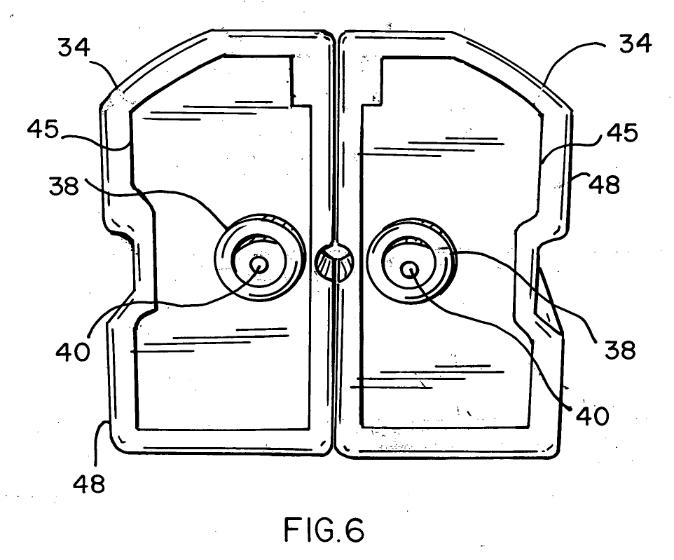

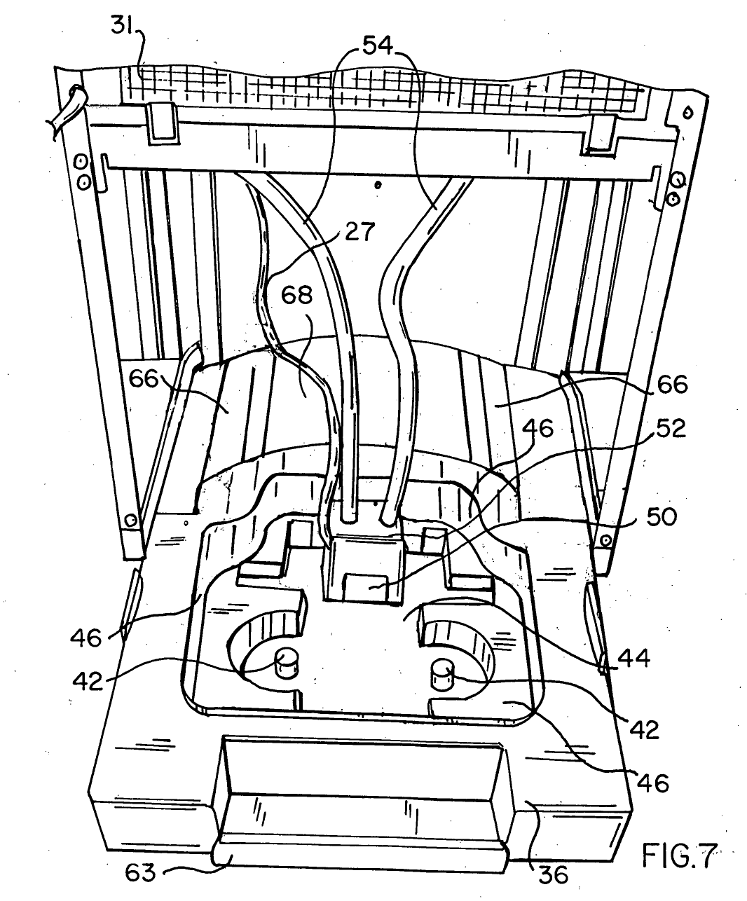

As seen in FIG. 6, each water tank 34 is fitted with a spring-biased valve assembly 38. An outwardly spring-biased plunger or poppet 40 on each valve 38 is adapted and positioned to engage a respective upwardly-projecting valve actuator 42 (FIG. 7) located in the bottom of the base tray 36. When a water tank 34 is properly mounted on the base tray 36, each sliding plunger 40 is depressed inwardly into tank 34 by an upwardly projecting actuator 42 to unseat a valve and allow water to flow freely from within each tank into a reservoir 44 molded into the floor of base tray 36.

To ensure proper positioning of the water tanks 34 on the base tray 36, an asymmetrical recess 46 (FIG. 7), keyed to receive the bottom sidewall contour 45 (FIG. 6) of the tanks 34, is formed in the floor of the base tray 36. Each recess 46 matches the shape of the outer contour or outer sidewall 45 of each asymmetrical bottom sidewall portion 48 of each water tank 34. The recesses 46 provide for a secure nested mounting of the water tanks 34, and through guided alignment ensure engagement between the valve actuators 42 and the valve plungers 40.

As further seen in FIG. 7, reservoir 44 communicates with the inlet or intake 50 of water pump 52. Pump 52 is mounted on the base tray 36 and moves in-and-out of the humidifier along with the base tray. The pump 52 pumps water from the reservoir 44 upwardly through a pair of hoses 54 to a pair of spray nozzles located adjacent the front face of honeycomb filter 30. When the pump 52 is turned on, water from reservoir 44 is sprayed onto the front face of the honeycomb filter 30 (FIGS. 4 and 8).

As seen in FIG. 8, a fan 60 having a single large diameter fan blade array is driven by an electrical motor 61. When motor 61 is turned on, the fan 60 draws air through the open grill in the top back panel 28, through the dust filter 31, and through the water-saturated honeycomb filter 30.

Air passing through the honeycomb filter 30 picks up moisture and is exhausted out the front of the humidifier through the front grill 16. By using a single large diameter fan blade array having a substantially horizontal axis of rotation, the moist air is quietly dispersed throughout the surrounding room in a uniform, substantially horizontal flow which quickly diffuses throughout the room without producing any wet spots.

It can be appreciated that a user need not lift the water tanks 34 from within the humidifier 10 when the tanks need to be refilled and replaced. Rather, the user need only slide or snap off the bottom back panel 26 and pull the base tray 36 outwardly by handle grip 63 (FIG. 7). Rollers or wheels 64 (FIG. 8) mounted on the base tray 36 (or alternatively on a rolling platform 65 which supports the base tray 36) roll within recessed tracks 66 (FIG. 7) formed in the bottom base or floor 68 of the housing or on platform 65 (FIG. 8). This rolling action greatly reduces resistance to movement and facilitates removal and installation of the water tank 34.

The housing fan and metal internal components of the humidifier are preferably made of stainless steel to prevent rusting. The base tray 36, bottom base 68 and top cover 20 are advantageously molded from plastic material to further avoid rusting.

As further seen in FIG. 8, a fan mounting frame 70 is mounted between the side panels 18 to support and position the fan 60 and fan motor 61. A filter frame 72 is also mounted between side panels 18 to support and position the filters 30, 31 in a centered position. A horizontal partition member 74 mounted between the fan 60 and water tanks 34 provides additional support to the humidifier 10, and aids in channeling and concentrating moist air through the front grill 16.

There has been disclosed heretofore the best embodiment of the invention presently contemplated. However, it is to be understood that various changes and modifications may be made thereto without departing from the spirit of the invention.

What is claimed is:

1. A humidifier, comprising:
a housing having a front air exhaust opening, a rear air intake opening, a top cover, and a bottom portion;
a water absorbent member mounted within said housing;
a fan mounted between said front exhaust opening and said water absorbent member; and
wherein said fan is aligned within said housing to blow moist air substantially horizontally out of said front exhaust opening.

2. The humidifier of claim 1, wherein said fan is mounted in an upper portion of said housing.

3. The humidifier of claim 1 further comprising a water tank disposed in said housing below said water absorbent member and below said fan.

4. The humidifier of claim 1, further comprising a movable base tray disposed in a lower portion of said housing.

5. The humidifier of claim 4, wherein said base tray comprises rollers.

6. The humidifier of claim 4, wherein said base tray further comprises a water reservoir.

7. The humidifier of claim 1, wherein said housing comprises an easily removable top back cover and an easily removable bottom back cover.

8. The humidifier of claim 1, further comprising a movable base tray provided in said bottom portion of said housing and a movable water pump carried by said movable base tray.

9. The humidifier of claim 8, further comprising a recess formed in said base tray and at least one water tank snugly held in position within said recess.

10. A humidifier, comprising:
a housing;
a fan mounted in said housing;
a movable tray mounted in said housing; and
a first water tank mounted on said movable tray.

11. The humidifier of claim 10, wherein said movable tray is movable into and out of said housing.

12. The humidifier of claim 10, further comprising a second water tray mounted on said movable tray.

13. The humidifier of claim 10, wherein said movable tray is mounted in a bottom portion of said housing.

14. The humidifier of claim 10, wherein said movable tray comprises rollers.

15. The humidifier of claim 1, wherein said housing comprises a bottom base and wherein said movable base tray moves over said bottom base.

16. The humidifier of claim 15, wherein said bottom base comprises a track and said movable base tray comprises rollers disposed in said track.

17. The humidifier of claim 1, wherein said housing comprises a removable bottom back cover easily opened for access to said movable tray.

18. The humidifier of claim 10, further comprising a water absorbent member mounted in said housing above said water tank.

19. The humidifier of claim 10, further comprising a water pump mounted on said movable tray.

20. The humidifier of claim 10, wherein said movable tray comprising a recess defining a water reservoir.
